(19) United States
(12) Patent Application Publication
(10) Pub. No.: US 2010/0271351 A1
(43) Pub. Date: Oct. 28, 2010

(54) METHOD FOR DRIVING PLASMA DISPLAY PANEL AND PLASMA DISPLAY DEVICE

(76) Inventors: Akihiro Takagi, Saitama (JP); Tetsuya Sakamoto, Kanagawa (JP); Takashi Sasaki, Kanagawa (JP)

Correspondence Address: MCDERMOTT WILL & EMERY LLP, 600 13TH STREET, N.W., WASHINGTON, DC, 20005-3096, US

(21) Appl. No.: 12/670,969

(22) PCT Filed: Jul. 27, 2007
(86) PCT No.: PCT/JP2007/000803

§ 371 Date: Jul. 7, 2010

(51) Int. Cl. G06F 3/038

(52) U.S. Cl. 345/206; 345/60

(57) ABSTRACT

A plasma display device includes a plasma display panel and a driver unit driving the plasma display panel. The plasma display panel includes a first plate on which a sustain electrode and a scan electrode, a dielectric layer, an address electrode extending in a direction intersecting with the sustain electrode, and a protective layer are sequentially stacked and a second plate disposed to face the first plate via a discharge space. On the second plate, a barrier rib extending in the direction intersecting with the sustain electrode is formed. One edge part of the address electrode lies on the barrier rib and the other edge part of the address electrode lies on the discharge space. During an address period, the driver unit applies a scan pulse operating as an anode to the scan electrode and applies an address pulse operating as a cathode to the address electrode. This makes it possible to prevent erroneous discharge.

### CROSS-REFERENCE TO THE RELATED APPLICATIONS

This application is the U.S. National Stage application claiming the benefit of prior filed International Application No. PCT/JP2007/000803, filed on Jul. 27, 2007, the entire contents of which are incorporated herein by reference.

### TECHNICAL FIELD

The present invention relates to a plasma display panel driving method and a plasma display device.

### BACKGROUND ART

A plasma display panel (PDP) is formed by adhering two glass plates (a front glass plate and a back glass plate) each other, and displays an image by generating discharge light in a space (discharge space) formed between the glass plates. A cell corresponding to a pixel in the image is of a self-luminescence type and coated with phosphors emitting red, green, and blue visible light under ultraviolet rays generated by discharge.

In general, the back glass plate has barrier ribs coated with the above-described phosphors, and the surface of the front glass plate is covered with a protective layer protecting a dielectric layer from discharge. Incidentally, in order to make discharge to occur easily, the protective layer is formed of a material having a high emission property of emitting secondary electrons by a collision with a positive ion. In the PDP, in order to display an image with a multiple gradation, a field for displaying one frame includes a plurality of subfields each including a reset period, an address period, and a sustain period, for example.

A PDP with a three-electrode structure having a sustain electrode, a scan electrode, and an address electrode displays an image by making sustain discharge occur between the sustain electrode and the scan electrode during a sustain period. A cell in which the sustain discharge is made to occur (a cell to be lit) is selected by making address discharge occur selectively between the scan electrode and the address electrode during an address period.

In recent years, a PDP in which three electrodes, a sustain electrode, a scan electrode, and an address electrode, are disposed on a front glass plate has been proposed (refer to, for example, Patent Document 1). For example, in this type of PDP, a negative pulse is applied to the scan electrode and a positive pulse is applied to the address electrode in order to make address discharge occur. Incidentally, in this type of PDP, the sustain electrode includes an X bus electrode and an X transparent electrode provided in each cell, and the scan electrode includes a Y bus electrode and a Y transparent electrode provided in each cell. In addition, the Y transparent electrodes of two cells adjacent to each other along the orthogonal direction of the address electrode are adjacent to each other with the address electrode in between.

In two Y transparent electrodes adjacent to each other with the address electrode in between, when address discharge is made to occur between one Y transparent electrode and the address electrode, there is a possibility that erroneous discharge occurs between the other Y transparent electrode and the address electrode. In order to prevent the erroneous discharge, a PDP has been proposed in which, in two Y transparent electrodes adjacent to each other with an address electrode in between, the distance between one Y transparent electrode and the address electrode is made shorter than the distance between the other Y transparent electrode and the address electrode (refer to, for example, Patent Document 2).

### Patent Document 1: Japanese Unexamined Patent Application Publication No. 2005-116508

### Patent Document 2: Japanese Unexamined Patent Application Publication No. 2006-302866

### DISCLOSURE

### Problems to be Solved

In a PDP having three electrodes on a front glass plate, two cells adjacent to each other along the orthogonal direction of an address electrode are separated from each other by a barrier rib extending in the direction in which the address electrode extends. However, since the barrier rib acts as part of a dielectric layer, an electric field is generated between a Y transparent electrode and an address electrode when a voltage is applied between the address electrode and a scan electrode (the Y transparent electrode), the Y transparent electrode being adjacent to the address electrode with the barrier rib in between. For example, in the PDP of Patent Document 2, when a negative pulse is applied to the scan electrode (the Y transparent electrode) and a positive pulse is applied to the address electrode in order to make address discharge occur, an electric field is generated from the address electrode in each of the two Y transparent electrodes adjacent to each other with the address electrode in between. As a result, in cells on both sides of the address electrode, when address discharge is made to occur in one of the cells, there is a possibility that, in the other cell, a positive ion being in the discharge space is drawn to the Y transparent electrode and collides with the protective layer on the Y transparent electrode. In this case, in the other cell, there is a possibility that secondary electrons are emitted from the protective layer on the Y transparent electrode, and erroneous discharge is made to occur.

A proposition of the present invention is to prevent erroneous discharge in a PDP having three electrodes on a front glass plate.

### Means for Solving the Problems

A plasma display device includes a plasma display panel and a driver unit driving the plasma display panel. In addition, the plasma display panel includes a first plate on which a sustain electrode and a scan electrode being adjacent to each other and plurally disposed, a dielectric layer, an address electrode extending in a direction intersecting with the sustain electrode, and a protective layer are sequentially stacked, and a second plate disposed to face the first plate via a discharge space. Furthermore, on the second plate, a barrier rib extending in the direction intersecting with the sustain electrode is formed. Incidentally, one edge part of the address electrode lies on the barrier rib and the other edge part of the address electrode lies on the discharge space. Moreover, one field for displaying one frame includes a plurality of subfields each having an address period. For example, during the address period, the driver unit applies a scan pulse operating as an anode to the scan electrode and applies an address pulse operating as a cathode to the address electrode.

According to the present invention, it is possible to prevent erroneous discharge in a PDP having three electrodes on a front glass plate.

### BRIEF DESCRIPTION OF THE DRAWINGS

FIG. 1 is an exploded perspective view showing an embodiment of the present invention.

FIG. 2 is an exploded perspective view showing the details of a principal portion of a PDP shown in FIG. 1.

FIG. 3 is an explanatory diagram of a principal portion of the PDP shown in FIG. 2.

FIG. 4 is a sectional view of the PDP shown in FIG. 3 taken on the line A-A′.

FIG. 5 is an explanatory diagram showing an example of the configuration of a field for displaying an image of one frame.

FIG. 6 is a waveform diagram showing an example of discharge operation of a subfield shown in FIG. 5.

FIG. 7 is a block diagram showing an outline of a circuit unit shown in FIG. 1.

FIG. 8 is an explanatory diagram of a principal portion of a PDP in a modified example of the present invention.

FIG. 9 is a sectional view of the PDP shown in FIG. 9 taken on the line A-A′.

FIG. 10 is a sectional view of a principal portion of a PDP in another modified example of the present invention.

### DETAILED DESCRIPTION OF THE EMBODIMENT

Hereinafter, an embodiment of the present invention will be described by using the drawings.

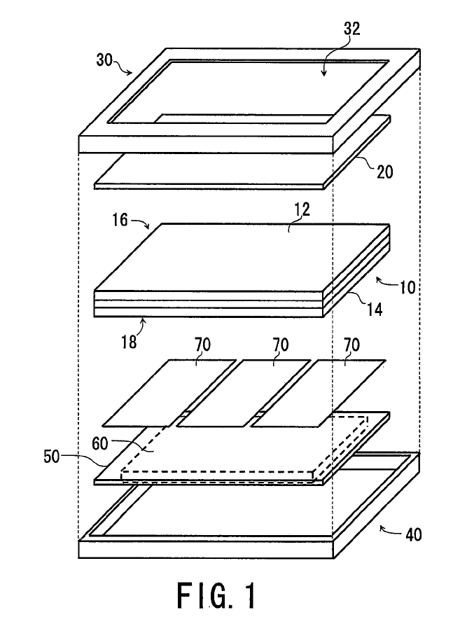

FIG. 1 shows an embodiment of the present invention. A plasma display device (hereinafter also referred to as a PDP device) includes a plasma display panel 10 (hereinafter also referred to as a PDP) in the form of a rectangular plate, an optical filter 20 provided on that side of the PDP 10 where an image display surface 16 is present (where light is output), a front case 30 disposed on that side of the PDP 10 where the image display surface 16 is present, a rear case 40 and a base chassis 50 which are disposed on that side of the PDP 10 where a back surface 18 is present, a circuit unit 60 for driving the PDP 10, the circuit unit 60 attached to that side of the base chassis 50 which faces the rear case 40, and a double-faced adhesive sheet 70 for adhering the PDP 10 to the base chassis 50. The circuit unit 60 is represented as a box indicated by dashed lines because the circuit unit 60 is made up of a plurality of parts.

The PDP 10 is made up of a front plate part 12 forming the image display surface 16 and a back plate part 14 facing the front plate part 12. Between the front plate part 12 and the back plate part 14, a discharge space (cell), not illustrated, is formed. The front plate part 12 and the back plate part 14 are formed of a glass plate, for example. The optical filter 20 is adhered to protection glass (not shown) fixed over an opening part 32 of the front case 30. Incidentally, the optical filter 20 may have the function of blocking electromagnetic waves. Moreover, instead of being adhered to the protection glass, the optical filter 20 may be directly adhered to that side of the PDP 10 where the image display surface 16 is present.

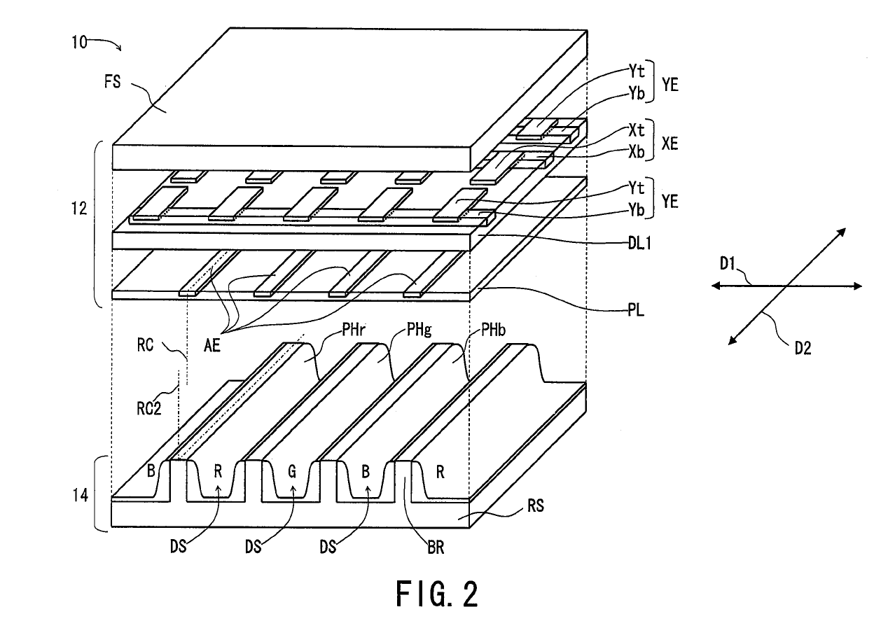

FIG. 2 shows the details of a principal portion of the PDP 10 shown in FIG. 1. An arrow D1 in the drawing represents a first direction D1, and an arrow D2 represents a second direction D2 orthogonal to the first direction D1 in a plane parallel to the image display surface.

The front plate part 12 has an X bus electrode Xb and a Y bus electrode Yb formed parallel on a glass base FS (a first plate) (in the drawing, on the underside thereof) along the first direction D1 and formed alternately along the second direction D2 so as to make discharge occur repeatedly. To the X bus electrode Xb, an X transparent electrode Xt extending in the second direction D2 from the X bus electrode Xb to the Y bus electrode Yb is coupled. Moreover, to the Y bus electrode Yb, a Y transparent electrode Yt extending in the second direction D2 from the Y bus electrode Yb to the X bus electrode Xb is coupled.

Here, the X bus electrode Xb and the Y bus electrode Yb are opaque electrodes formed of a metal material or the like, and the X transparent electrode Xt and the Y transparent electrode Yt are transparent electrodes allowing light to pass therethrough, the transparent electrodes formed of a film of ITO or the like. In addition, a sustain electrode XE is made up of the X bus electrode Xb and the X transparent electrode Xt, and a scan electrode YE is made up of the Y bus electrode Yb and the Y transparent electrode Yt. Incidentally, the transparent electrodes Xt and Yt are sometimes disposed on the entire surface between the bus electrodes Xb and Yb to which the transparent electrodes Xt and Yt are coupled, respectively, and the glass base FS. Furthermore, an electrode into which the bus electrodes Xb and Yb are integrated together may be formed of the same material (a metal material or the like) as the bus electrodes Xb and Yb in place of the transparent electrodes Xt and Yt.

The electrodes Xb, Xt, Yb, and Yt are covered with a dielectric layer DL1. For example, the dielectric layer DL1 is a silicon dioxide film (a film of SiO₂, a film of silicon dioxide) formed by CVD. In addition, on the dielectric layer DL1 (in the drawing, on the underside thereof), a plurality of address electrodes AE extending in the orthogonal direction (the second direction D2) of the bus electrodes Xb and Yb are provided. As described above, the PDP of this embodiment includes three electrodes (the electrodes XE, YE, and AE) in the front plate part 12.

Moreover, the address electrodes AE and the dielectric layer DL1 are covered with a protective layer PL. For example, in order to make discharge more likely to occur, the protective layer PL is formed of a film of MgO having a high emission property of emitting secondary electrons by a collision with a positive ion. As described above, in this embodiment, on the glass base FS, the sustain electrode XE and the scan electrode YE formed parallel to each other, the dielectric layer DL1, the address electrodes AE extending in the orthogonal direction of the sustain electrode XE, and the protective layer PL are sequentially stacked.

The back plate part 14 facing the front plate part 12 via a discharge space DS has, on a glass base RS (a second plate), barrier ribs BR extending in the direction (the second direction D2) orthogonal to the bus electrodes Xb and Yb and formed parallel to one another. Incidentally, the barrier ribs BR each have a central axis RC2 in a position off a central axis RC of the address electrode AE as viewed from a direction perpendicular to the glass base FS, and, in part thereof, face the address electrode AE. The barrier ribs BR form the side walls of a cell. Furthermore, on the side surfaces of the barrier ribs BR and on the glass base RS between the barrier ribs BR adjacent to each other, phosphors PHr, PHg, and PHb emitting red (R), green (g), and blue (B) visible light as a result of being excited by ultraviolet rays are applied.

One pixel of the PDP 10 is made up of three cells emitting red, green, and blue light. Here, one cell (a pixel of one color) is formed in the discharge space DS defined by the bus electrodes Xb and Yb and the barrier ribs BR. As described above, the PDP 10 is formed by arranging the cells for displaying an image in a matrix and arranging a plurality of types of cells alternately, the cells emitting light of different colors. Though not shown in the drawing, the cells formed along the bus electrodes Xb and Yb form a display line.

The PDP 10 is formed by adhering the front plate part 12 and the back plate part 14 each other in such a way that the protective layer PL and the barrier ribs BR are brought into contact with each other and encapsulating discharge gas such as Ne or Xe in the discharge space DS.

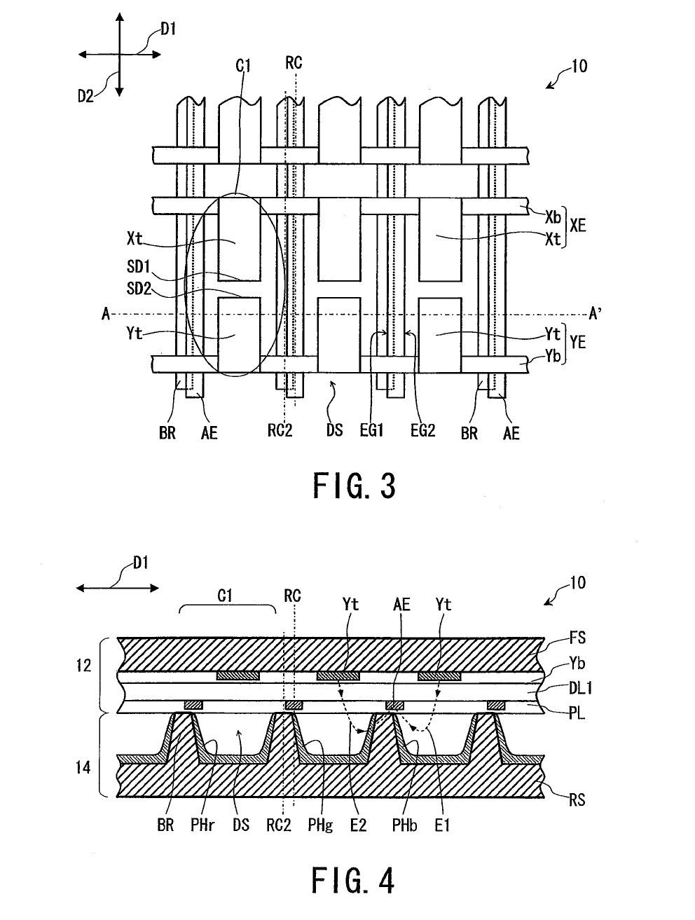

FIG. 3 shows a principal portion of the PDP 10 viewed from the image display surface side (the upper side of FIG. 2). Incidentally, FIG. 3 shows a state of the electrodes Xb, Xt, Yb, Yt, and AE and the barrier ribs BR viewed from the image display surface side. The meaning of the arrows in the drawing is the same as that of FIG. 2 described above.

As viewed from the image display surface side, a cell C1 is formed in a region defined by the bus electrodes Xb and Yb and the barrier ribs BR, and the discharge space DS of each cell C1 is formed between the barrier ribs BR adjacent to each other. In addition, each address electrode AE faces, in part thereof, one of the barrier ribs BR (in the drawing, the left one) forming the discharge space DS of the cell C1 corresponding to the address electrode AE. One edge part EG1 of the address electrode AE along the second direction D2 lies on the barrier rib BR, and the other edge part EG2 lies on the discharge space DS. In other words, as viewed from the image display surface side, the barrier rib BR is provided in a position where the barrier rib BR has a central axis RC2 in a position off a central axis RC of the address electrode AE (in the drawing, a position off a central axis RC leftward), and part thereof overlaps the address electrode AE.

That is, part of the address electrode AE is disposed in such a way as to stick out from the barrier rib BR toward the transparent electrode Yt corresponding to the address electrode AE (in the drawing, the transparent electrode Yt located on the right side of the address electrode AE). As a result, by applying a voltage between the address electrode AE and the transparent electrode Yt, it is possible to make address discharge occur in the discharge space DS of a particular cell C1 (hereinafter also referred to as a selection cell). At this time, the barrier rib BR also acts as part of the dielectric layer, and an electric field between the address electrode AE and the transparent electrode Yt is generated in the discharge space DS.

Incidentally, in two transparent electrodes Yt adjacent to each other with the address electrode AE in between, part of the address electrode AE is disposed in such a way as to stick out from the barrier rib BR only toward one of the transparent electrodes Yt (in the drawing, rightward). As a result, when address discharge is made to occur between the address electrode AE and the transparent electrode Yt of the selection cell C1 (during an address period), it is possible to reduce the possibility that erroneous discharge occurs in a cell C1 (hereinafter also referred to as a non-selection cell) adjacent to the selection cell C1.

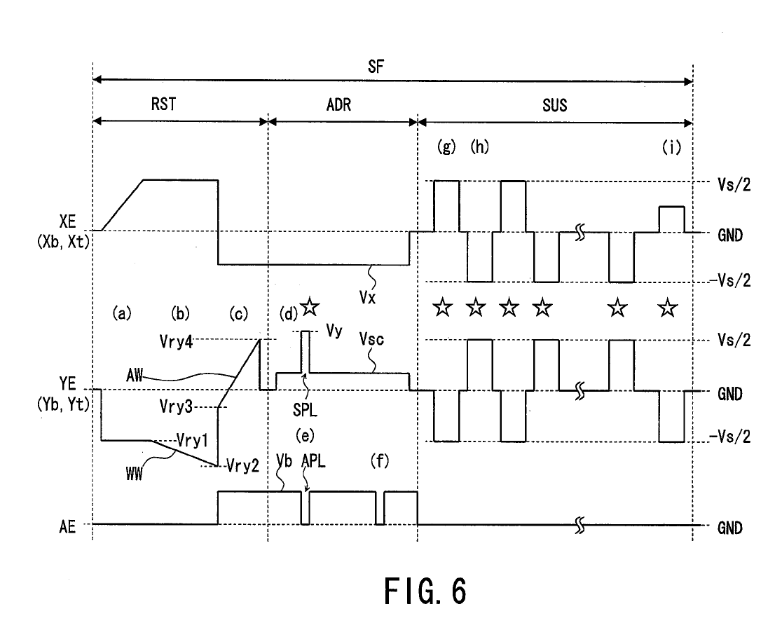

Moreover, the transparent electrode Xt and the transparent electrode Yt are disposed in such a way that the ends SD1 and SD2 face each other. As a result, during a sustain period SUS of FIG. 6, which will be described later, by applying a voltage between the transparent electrode Xt and the transparent electrode Yt, it is possible to make sustain discharge occur in the discharge space DS of the particular cell C1.

FIG. 4 shows the cross-section of the PDP 10 taken on the line A-A′ of FIG. 3. The meaning of the arrows in the drawing is the same as that of FIG. 2 described above. In this embodiment, the discharge spaces DS adjacent to one another in the first direction D1 are separated from one another by the barrier ribs BR. In addition, as described above, part of the address electrode AE is disposed in such a way as to stick out from the barrier rib BR only toward the transparent electrode Yt corresponding to the address electrode AE. Accordingly, the protective layer PL on the address electrode AE is exposed only in the discharge space DS on the transparent electrode Yt side (in the drawing, on the right side), the transparent electrode Yt corresponding to the address electrode AE.

In this embodiment, in order to make address discharge occur in the discharge space DS of the selection cell C1, as shown in FIG. 6, which will be described later, a scan pulse SPL operating as an anode is applied to the scan electrode YE, and an address pulse APL operating as a cathode is applied to the address electrode AE. That is, in this embodiment, address discharge is made to occur by making the address electrode AE serve as a cathode and the transparent electrode Yt (the scan electrode YE) serve as an anode. In this case, from two transparent electrodes Yt adjacent to each other with the address electrode AE in between, electric fields E1 and E2 are generated in the address electrode AE. Here, the electric field E1 is generated between the address electrode AE and a transparent electrode Yt of the selection cell C1 side which corresponds to the address electrode AE, and the electric field E2 is generated between the address electrode AE and a transparent electrode Yt of the non-selection cell C1 side which does not correspond to the address electrode AE. In the example of the drawing, since the distance between the transparent electrode Yt of the non-selection cell C1 and the address electrode AE of the selection cell C1 is greater than the distance between the transparent electrode Yt of the selection cell C1 and the address electrode AE of the selection cell C1, the electric field E2 is weaker than the electric field E1.

Positive ions present in the discharge space DS of the selection cell C1 are drawn to the address electrode AE, and collide with the protective layer PL on the address electrode AE. As a result, secondary electrons are emitted from the protective layer PL, whereby address discharge occurs efficiently. Moreover, even when positive ions present in the discharge space DS of the non-selection cell C1 are drawn to the address electrode AE, the positive ions do not reach the protective layer PL on the address electrode AE as a result of being obstructed by the barrier rib BR. As a result, no erroneous discharge occurs in the non-selection cell C1.

That is, in this embodiment, when address discharge is made to occur between the address electrode AE and the transparent electrode Yt of the selection cell C1 (during an address period), it is possible to prevent erroneous discharge from occurring in the non-selection cell C1 adjacent to the selection cell C1. Incidentally, since no discharge (erroneous discharge) occurs in the non-selection cell C1, positive ions colliding with the phosphors PHr, PHg, and PHb applied to the barrier ribs BR do not increase due to discharge. Therefore, the collision of the positive ions with the phosphors has no influence on deterioration of image quality of the PDP 10.

Moreover, in this embodiment, by making the address electrode AE serve as a cathode and the transparent electrode Yt (the scan electrode YE) serve as an anode, positive ions are collided with the protective layer PL on the address electrode AE, and secondary electrons are emitted from the protective layer PL. Here, the protective layer PL on the address electrode AE deteriorates to a far lesser extent than the protective layer PL on the transparent electrodes Xt and Yt. This is because the protective layer PL on the transparent electrodes Xt and Yt deteriorates greatly at the time of sustain discharge. In this embodiment, since the protective layer PL on the address electrode AE does not suffer much deterioration, it is possible to prevent deterioration of characteristics such as discharge time lag in address discharge.

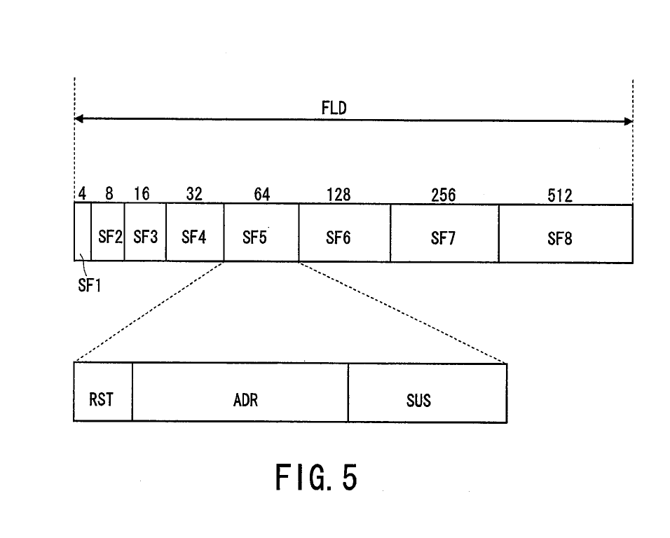

FIG. 5 shows an example of the configuration of a field FLD for displaying an image of one frame. One field FLD is 1/60 second (about 16.7 ms) in length, and is made up of eight subfields SF (SF1-SF8), for example. Each subfield SF is made up of a reset period RST, an address period ADR, and a sustain period SUS. Incidentally, in this embodiment, an erase period during which discharge for reducing the wall charges of only a lit cell is made to occur (for example, FIG. 6(i), which will be described later) is defined as being included in the sustain period SUS. Moreover, the erase period is sometimes defined separately from the sustain period SUS. Here, the wall charges are, for example, a positive charge and a negative charge accumulated on the surface of the protective layer PL shown in FIG. 2 in each cell, the protective layer PL formed of MgO or the like.

The length of the sustain period SUS differs according to each subfield SF, and depends on the number of discharges (luminance) of a cell. Therefore, by changing the combination of the subfields SF to be lit, it is possible to display an image with a multiple gradation. In this example, the numbers of sustain discharges previously set for the subfields SF1-8 are 4, 8, 16, 32, 64, 128, 256, and 512, respectively. As shown in FIG. 6, which will be described later, a cell discharges twice in one discharge cycle CYC (star signs in the drawing).

FIG. 6 shows an example of discharge operation of the subfield SF shown in FIG. 5. A star sign in the drawing represents the occurrence of discharge.

First, during the reset period RST, a slowly increasing positive voltage (a slope pulse) is applied to the sustain electrode XE (the bus electrode Xb and the transparent electrode Xt), and a negative voltage Vry1 (a first voltage) is applied to the scan electrode YE (the bus electrode Yb and the transparent electrode Yt) (FIG. 6(a)). In addition, the sustain electrode XE is maintained at a positive write voltage, and a negative write voltage (a write slope pulse voltage WW) decreasing slowly from the voltage Vry1 to a voltage Vry2 (a second voltage) is applied to the scan electrode YE (FIG. 6(b)). This allows negative and positive wall charges to be accumulated in the sustain electrode XE and the scan electrode YE, respectively, while preventing the luminescence of the cell.

Next, a negative voltage Vx is applied to the sustain electrode XE, a positive adjusting voltage (an adjusting slope pulse voltage AW) increasing slowly from a voltage Vry3 (a third voltage) to a voltage Vry4 (a fourth voltage) is applied to the scan electrode YE, and a positive voltage Vb is applied to the address electrode AE (FIG. 6(c)). This makes it possible to adjust the amounts of wall charges accumulated in the sustain electrode XE, the scan electrode YE, and the address electrode AE. Incidentally, for example, the negative voltage Vx is a voltage higher than a voltage -Vs/2, the voltage Vry3 of the adjusting slope pulse voltage AW is a voltage equal to or higher than the voltage Vry1, and the voltage Vry4 of the adjusting slope pulse voltage AW is a voltage higher than a voltage Vs/2. By making the voltage Vry4 higher than the voltage Vs/2, in this embodiment, it is possible to prevent erroneous discharge from occurring between the scan electrode YE and the address electrode AE during the sustain period SUS.

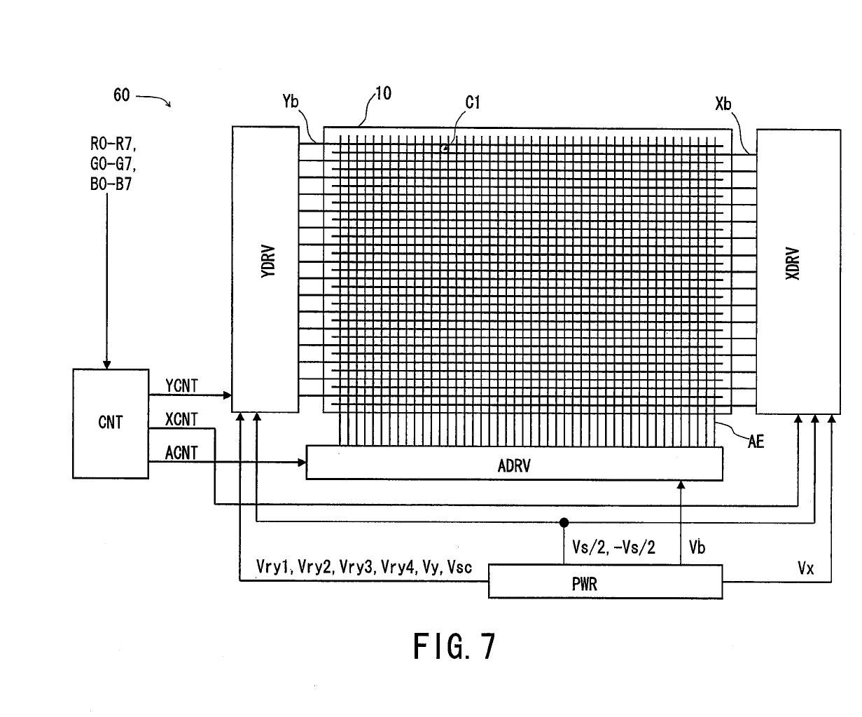

Moreover, since the positive voltage Vb is applied to the address electrode AE while the adjusting slope pulse voltage AW is being applied to the scan electrode YE, an address pulse APL operating as a cathode, the address pulse APL of the address period ADR, may change to the negative side with respect to the positive voltage Vb. That is, in this embodiment, it is possible to apply the address pulse APL operating as a cathode to the address electrode AE without using a negative voltage lower than a voltage GND. This makes it possible to simplify a design of a driver circuit (for example, a driver ADRV shown in FIG. 7, which will be described later) for applying a voltage to the address electrode AE.

During the address period ADR, the sustain electrode XE is maintained at the negative voltage Vx, a positive non-selection voltage Vsc is applied to the scan electrode YE, and the address electrode AE is maintained at the positive voltage Vb (FIG. 6(d)). In addition, the sustain electrode XE is maintained at the negative voltage Vx, a scan pulse SPL (a voltage Vy) operating as an anode is applied to the scan electrode YE, and an address pulse APL (a voltage GND of a grounding conductor) operating as a cathode is applied to the address electrode AE corresponding to a cell to be lit (a selection cell) (FIG. 6(e)). For example, the scan pulse SPL operating as an anode is a positive pulse, and the voltage Vy of the scan pulse SPL is a voltage higher than the voltage Vs/2. Furthermore, the address pulse APL operating as a cathode is a negative pulse, for example.

In the cell (the selection cell) selected by the scan pulse SPL and the address pulse APL, discharge (address discharge) temporarily occurs. That is, a voltage equal to or higher than a minimum voltage (a firing voltage) making discharge occur is applied between the scan electrode YE and the address electrode AE, and a voltage lower than the firing voltage is applied between the sustain electrode XE and the address electrode AE. This makes it possible to prevent erroneous discharge from occurring between the sustain electrode XE and the address electrode AE when address discharge is made to occur between the address electrode AE and the scan electrode YE.

Incidentally, in this embodiment, the voltage Vy of the scan pulse SPL is a voltage higher than the voltage Vry4. For example, the voltage Vy is about 10 V higher than the voltage Vry4. This makes it possible to reduce the amplitude (the voltage Vb—the voltage GND) of the address pulse APL and make the driving force of a driver circuit (for example, a driver ADRV shown in FIG. 7, which will be described later) small, the driver circuit for applying a voltage to the address electrode AE. Incidentally, the voltage difference between the voltage Vy and the voltage Vb is smaller than the firing voltage between the address electrode AE and the scan electrode YE. This makes it possible to prevent erroneous discharge from occurring between the address electrode AE maintained at the voltage Vb and the scan electrode YE to which the scan pulse SPL (the voltage Vy) has been applied.

Moreover, the sustain electrode XE becomes a cathode for the scan electrode YE by the negative voltage Vx at the time of address discharge. The scan electrode YE becomes an anode for the sustain electrode XE and the address electrode AE by the voltage Vy (the scan pulse SPL operating as an anode) at the time of address discharge. As a result, in the cell selected by the address discharge, positive and negative wall charges are accumulated in the sustain electrode XE and the scan electrode YE, respectively. Furthermore, the address electrode AE becomes a cathode for the scan electrode YE by the voltage GND (the address pulse APL operating as a cathode) of the grounding conductor, the voltage GND lower than the voltage Vy, at the time of address discharge.

As explained in FIG. 4 described above, since address discharge is made to occur by making the address electrode AE of the selection cell C1 serve as a cathode, it is possible to prevent positive ions present in the discharge space DS of a non-selection cell C1 from colliding with the protective layer PL, and thereby prevent erroneous discharge from occurring in the non-selection cell C1. On the other hand, when address discharge is made to occur by, for example, making the address electrode AE serve as an anode and the transparent electrode Yt (the scan electrode YE) serve as a cathode, electric fields (in a direction opposite to the electric field E1 and in a direction opposite to the electric field E2, the electric fields E1 and E2 shown in FIG. 4 described above) are generated from the address electrode AE in two transparent electrodes Yt adjacent to each other with the address electrode AE in between. As a result, there is a possibility that positive ions present in the discharge space of the non-selection cell C1 are drawn to the transparent electrode Yt and collide with the protective layer PL on the transparent electrode Yt. In this case, in the non-selection cell C1, there is a possibility that secondary electrons are emitted from the protective layer PL on the transparent electrode Yt and erroneous discharge occurs.

The second address pulse APL shown in the waveform of the address electrode AE is applied to select a cell in another display line (FIG. 6(f)). Incidentally, when no scan pulse SPL is applied to the scan electrode YE, a non-selection voltage Vsc lower than the voltage Vy and the voltage Vry4 is applied to the scan electrode YE. That is, during the address period ADR, a predetermined voltage (a non-selection voltage Vsc) lower than the voltage Vy is applied to the scan electrode YE to which no scan pulse SPL is applied. As a result, in this embodiment, it is possible to reduce the amount of change in voltage (the voltage Vy—the voltage Vsc) when a scan pulse SPL is applied, and make the driving force of a driver circuit (for example, a driver YDRV shown in FIG. 7, which will be described later) small, the driver circuit for applying a voltage to the scan electrode YE.

Incidentally, the voltage difference between the non-selection voltage Vsc and the address pulse APL (the voltage GND) is smaller than the firing voltage between the address electrode AE and the scan electrode YE. For example, the non-selection voltage Vsc is smaller than a final voltage (the voltage difference between the voltage Vry4 and the voltage Vb) between the scan electrode YE and the address electrode AE when the adjusting slope pulse voltage AW is applied to the scan electrode YE (FIG. 6(c)). This makes it possible to prevent erroneous discharge from occurring between the scan electrode YE maintained at the non-selection voltage Vsc and the address electrode AE when the address pulse APL for selecting a cell in another display line is applied to the address electrode AE (FIG. 6(f)).

During the sustain period SUS, in the beginning, a positive sustain pulse (a high-level voltage Vs/2) is applied to the sustain electrode XE, a negative sustain pulse (a low-level voltage −Vs/2) is applied to the scan electrode YE, and a voltage GND of the grounding conductor is applied to the address electrode AE (FIG. 6(g)). Since positive and negative wall charges have been accumulated in the sustain electrode XE and the scan electrode YE, respectively, in a cell (a cell to be lit) selected during the address period ADR, the voltage difference between the sustain electrode XE and the scan electrode YE becomes greater than the voltage difference (the voltage Vs) between the positive and negative sustain pulses. As a result, in the cell to be lit, the voltage difference between the sustain electrode XE and the scan electrode YE becomes greater than the firing voltage between the sustain electrode XE and the scan electrode YE, and discharge occurs between the sustain electrode XE and the scan electrode YE.

In this embodiment, since it is possible to make discharge occur between the sustain electrode XE and the scan electrode YE by the first sustain pulse, the sustain period SUS or the field FLD can be used effectively. Incidentally, in the cell (the cell to be lit) in which discharge has occurred, negative and positive wall charges are respectively accumulated in the sustain electrode XE to which the positive sustain pulse has been applied and the scan electrode YE to which the negative sustain pulse has been applied.

Next, negative and positive sustain pulses are applied to the sustain electrode XE and the scan electrode YE, respectively (FIG. 6(h)). In the cell (the cell to be lit) in which the discharge occurred in the sustain pulse shown in FIG. 6(g) which is immediately before the sustain pulse shown in FIG. 6(h), since the negative and positive wall charges have been accumulated in the sustain electrode XE and the scan electrode YE, respectively, discharge occurs between the sustain electrode XE and the scan electrode YE. As a result, a discharge state of the lit cell is maintained. Incidentally, in the cell in which discharge has occurred, positive and negative wall charges are respectively accumulated in the sustain electrode XE to which the negative sustain pulse has been applied and the scan electrode YE to which the positive sustain pulse has been applied. As a result of the sustain pulses having different polarities being applied to the sustain electrode XE and the scan electrode YE repeatedly (FIG. 6(g, h)), discharge of the lit cell during the sustain period SUS is repeatedly performed.

Finally, a positive erase pulse and a negative erase pulse are applied to the sustain electrode XE and the scan electrode YE, respectively (FIG. 6(i)). As a result, discharge for reducing the wall charges of only a lit cell occurs. Since the difference in voltage value between the positive and negative erase pulses is smaller than the difference in voltage value between the positive and negative sustain pulses, the amount of wall charges is reduced. It is to be noted that, in a driver XDRV shown in FIG. 7 or the like, which will be described later, a circuit for applying a predetermined voltage (for example, a positive erase pulse) to the sustain electrode XE during the reset period RST and the sustain period SUS is not shown.

FIG. 7 shows an outline of the circuit unit 60 shown in FIG. 1. The circuit unit 60 includes an X driver XDRV applying a common pulse to the bus electrodes Xb, a Y driver YDRV selectively applying a pulse to the bus electrodes Yb, an address driver ADRV selectively applying a pulse to the address electrodes AE, a control unit CNT controlling the operation of the drivers XDRV, YDRV, and ADRV, and a power supply unit PWR.

The drivers XDRV, YDRV, and ADRV operate as a driver unit driving the PDP 10. For example, the drivers XDRV, YDRV, and ADRV operate as a driver unit applying the voltages shown in FIG. 6 described above to the electrodes XE, YE, and AE. The power supply unit PWR generates power-supply voltages Vry1, Vry2, Vry3, Vry4, Vsc, Vy, Vs/2, −Vs/2, Vx, Vb, and the like, to be supplied to the drivers YDRV, XDRV, and ADRV.

Based on image data R0-7, G0-7, and B0-7, the control unit CNT selects a subfield to be used, and outputs control signals YCNT, XCNT, and ACNT to the drivers YDRV, XDRV, and ADRV. In addition, by selecting a subfield to be used for each cell C1 forming a pixel, an image with a multiple gradation is displayed. Incidentally, the image data R0-7, G0-7, and B0-7 is data of 8 bits for displaying red, green, and blue, respectively, and is sequentially input to the control unit CNT from a tuner unit, not illustrated, or external input.

As described above, in this embodiment, during the address period ADR, a scan pulse SPL (a voltage Vy) operating as an anode is applied to the scan electrode YE, and an address pulse APL (a voltage GND of the grounding conductor) operating as a cathode is applied to the address electrode AE corresponding to a cell to be lit (a selection cell). As a result, in the selection cell, secondary electrons are emitted from the protective layer PL, and address discharge occurs. In a non-selection cell, since no secondary electrons are emitted from the protective layer PL, no discharge (erroneous discharge) occurs. That is, in this embodiment, it is possible to prevent erroneous discharge.

Moreover, during the reset period RST, a slowly decreasing negative write slope pulse voltage WW is applied to the scan electrode YE, and thereafter a slowly increasing positive adjusting slope pulse voltage AW is applied to the scan electrode YE. As a result, in this embodiment, it is possible to accumulate negative and positive wall charges in the sustain electrode XE and the scan electrode YE, respectively, during the reset period RST while preventing the luminescence of the cell, and equalize the wall charges of all the cells C1.

Incidentally, the voltage value (the voltage Vy) of the scan pulse SPL is higher than the voltage Vry4. As a result, in this embodiment, it is possible to reduce the amplitude (the voltage Vb—the voltage GND) of the address pulse APL, and make the driving force of the driver ADRV shown in FIG. 7, for example, small.

Furthermore, during the address period ADR, a non-selection voltage Vsc lower than the voltage Vy is applied to the scan electrode YE to which no scan pulse SPL is applied. As a result, in this embodiment, it is possible to reduce the amount of change in voltage (the voltage Vy—the voltage Vsc) when the scan pulse SPL is applied, and make the driving force of the driver YDRV shown in FIG. 7, for example, small.

Moreover, at the outset of the sustain period SUS, positive and negative sustain pulses are applied to the sustain electrode XE and the scan electrode YE, respectively. As a result, in this embodiment, it is possible to make discharge occur between the sustain electrode XE and the scan electrode YE by the first sustain pulse, and use the sustain period SUS or the field FLD effectively.

Incidentally, in the embodiment described above, an example in which one pixel is made up of three cells (red (R), green (G), and blue (B)) has been described. The present invention, however, is not limited to such an embodiment. For example, one pixel may be made up of four or more cells. Alternatively, one pixel may be made up of cells generating a color other than red (R), green (G), and blue (B), or one pixel may include a cell generating a color other than red (R), green (G), and blue (B).

In the embodiment described above, an example in which the voltage value (the voltage Vy) of the scan pulse SPL is higher than the voltage Vry4 has been described. The present invention, however, is not limited to such an embodiment. For example, the voltage value (the voltage Vy) of the scan pulse SPL may have the same voltage value as the voltage Vry4. Also in this case, it is possible to prevent erroneous discharge during the address period ADR.

In the embodiment described above, an example in which the non-selection voltage Vsc lower than the voltage Vy is applied, during the address period ADR, to the scan electrode YE to which no scan pulse SPL is applied has been described. The present invention, however, is not limited to such an embodiment. For example, no non-selection voltage Vsc may be applied to the scan electrode YE, and the scan electrode YE may be maintained at the voltage GND. Also in this case, it is possible to prevent erroneous discharge during the address period ADR.

In the embodiment described above, an example in which the positive voltage Vb is applied to the address electrode AE while the adjusting slope pulse voltage AW is being applied to the scan electrode YE during the reset period RST has been described. The present invention, however, is not limited to such an embodiment. For example, the address electrode AE may be maintained at the voltage GND during the reset period RST, and the positive voltage Vb may be applied to the address electrode AE during the address period ADR. Also in this case, it is possible to obtain the same effects as those obtained in the embodiment described above.

In the embodiment described above, an example in which positive and negative sustain pulses (a high-level voltage Vs/2 and a low-level voltage −Vs/2) which are equal in amplitude (absolute value) from the voltage GND of the grounding conductor are alternately applied to the sustain electrode XE and the scan electrode YE has been described. The present invention, however, is not limited to such an embodiment. For example, a sustain pulse changing from the voltage GND (a low-level voltage) of the grounding conductor to the voltage Vs (a high-level voltage) may be alternately applied to the sustain electrode XE and the scan electrode YE. Also in this case, it is possible to obtain the same effects as those obtained in the embodiment described above.

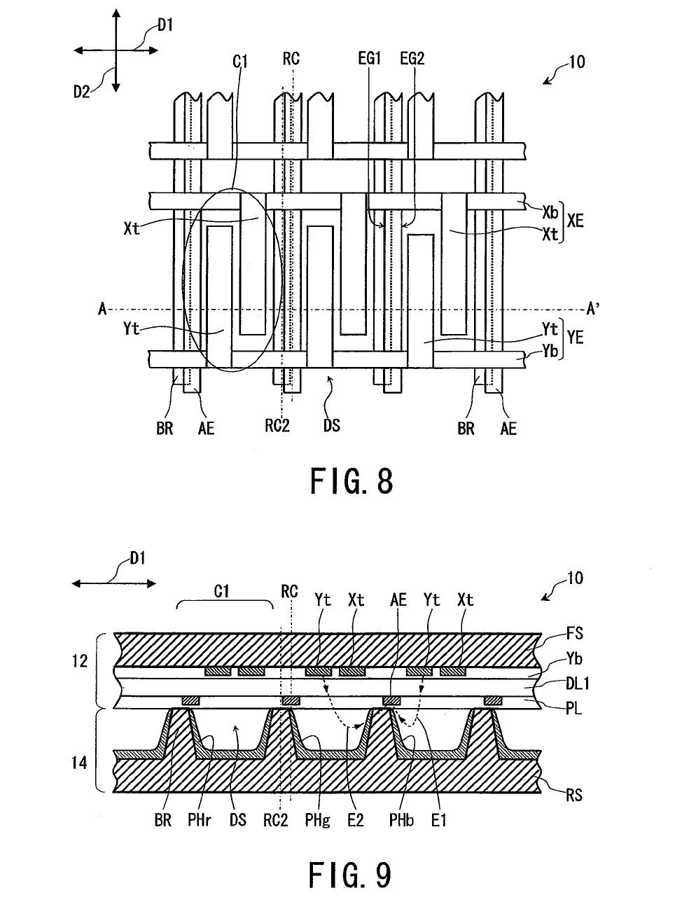

In the embodiment described above, an example in which, in cells C1 located on both sides of a particular address electrode AE, the transparent electrodes Yt of the cells are disposed in positions adjacent to each other with the address electrode in between has been described. The present invention, however, is not limited to such an embodiment. For example, as shown in FIG. 8, in cells C1 located on both sides of a particular address electrode AE, only the transparent electrode Yt of one of the cells C1 may be disposed in a position adjacent to the address electrode AE. A PDP of FIG. 8 differs from the embodiment described above in the arrangement of the transparent electrodes Xt and Yt. Other configurations are the same as those of the embodiment described above. In the PDP of FIG. 8, the transparent electrodes Xt and Yt face each other along the second direction, and sustain discharge occurs in that portion where the transparent electrodes Xt and Yt face each other. Incidentally, regardless of the arrangement or shape of the transparent electrodes Xt and Yt, the present invention can be applied to a PDP having three electrodes (a sustain electrode XE, a scan electrode YE, and an address electrode AE) on a glass base FS.

FIG. 9 shows the cross-section of the PDP 10 taken on the line A-A′ of FIG. 8. In cells C1 (a selection cell C1 and a non-selection cell C1) located on both sides of a particular address electrode AE, an electric field E1 is generated in the address electrode AE from the transparent electrode Yt of one cell C1 (the selection cell C1), and an electric field E2 is generated in the address electrode AE from the transparent electrode Yt of the other cell C1 (the non-selection cell C1). The difference between the distance between the transparent electrode Yt of the non-selection cell C1 and the address electrode AE of the selection cell C1 and the distance between the transparent electrode Yt of the selection cell C1 and the address electrode AE of the selection cell C1 is greater than that of the embodiment described above. As a result, the electric field E2 is still weaker than the electric field E1. Therefore, in the non-selection cell C1, the amount of positive ions colliding with the phosphors PHr, PHg, and PHb applied to the barrier ribs BR is less than that of the embodiment described above. Also in this case, it is possible to obtain the same effects as those obtained in the embodiment described above.

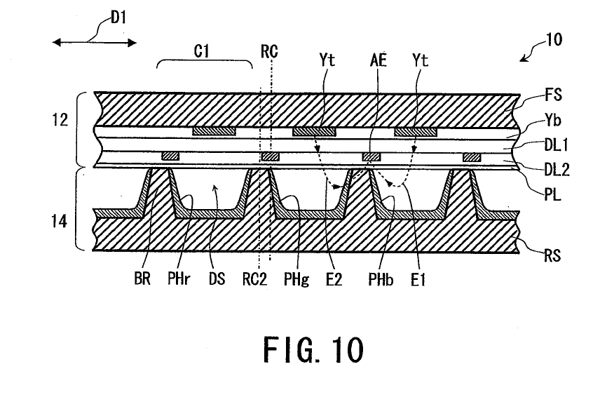

In the embodiment described above, an example in which the address electrode AE and the dielectric layer DL1 are directly covered with the protective layer PL has been described. The present invention, however, is not limited to such an embodiment. For example, as shown in FIG. 10, the address electrode AE and the dielectric layer DL1 may be covered with the protective layer PL with a dielectric layer DL2 interposed between them and the protective layer PL. FIG. 10 corresponds to the cross-section of the PDP 10 taken on the line A-A′ of FIG. 3. The PDP of FIG. 10 is configured by adding the dielectric layer DL2 to the embodiment described above. Other configurations are the same as those of the embodiment described above. The dielectric layer DL2 is provided on the dielectric layer DL1, and covers the address electrode AE. In addition, the surface of the dielectric layer DL2 is covered with the protective layer PL. Therefore, in the PDP of FIG. 10, on the glass base FS, the sustain electrode XE and the scan electrode YE formed parallel to each other, the dielectric layer DL1, the address electrode AE extending in the orthogonal direction of the sustain electrode XE, and the protective layer PL are sequentially stacked. Also in this case, it is possible to obtain the same effects as those obtained in the embodiment described above.

In the embodiment described above, an example in which the barrier ribs BR are disposed only in positions facing the address electrodes AE has been described. The present invention, however, is not limited to such an embodiment. For example, a barrier rib extending in the vertical direction of the address electrode AE (the first direction D1 shown in FIG. 2 described above) may be provided on the glass base RS. In this case, for example, the barrier ribs extending in the first direction D1 are disposed in positions facing the bus electrodes Xb and Yb, and are formed so as to be lower than the barrier ribs BR. This makes it possible to set the discharge space DS of the assembled PDP 10 in a vacuum state by means of an exhaust space ES without being blocked by the barrier ribs extending in the first direction D1, and encapsulate discharge gas in the discharge space DS. Also in this case, it is possible to obtain the same effects as those obtained in the embodiment described above.

Although the present invention has been described in detail, it is to be understood that the embodiment described above and the modified example thereof are by way of illustration and example only and are not to be taken by way of limitation. Obviously, various modifications are possible within the scope of the present invention.

The many features and advantages of the embodiment are apparent from the detailed specification and, thus, it is intended by the appended claims to cover all such features and advantages of the embodiment that fall within the true spirit and scope thereof. Further, since numerous modifications and changes will readily occur to those skilled in the art, it is not desired to limit the inventive embodiment to exact construction and operation illustrated and described, and accordingly all suitable modifications and equivalents may be resorted to, falling within the scope thereof.

1. A driving method of a plasma display panel which includes:
a first plate on which a sustain electrode and a scan electrode being adjacent to each other and plurally disposed, a dielectric layer, an address electrode extending in a direction intersecting with the sustain electrode, and a protective layer are sequentially stacked; and
a barrier rib which is formed on a second plate disposed to face the first plate via a discharge space and which extends in the direction intersecting with the sustain electrode, in which one edge part of the address electrode lies on the barrier rib and the other edge part of the address electrode lies on the discharge space, wherein one field for displaying one frame includes a plurality of subfields each having an address period, the driving method comprising the operation of
applying a scan pulse operating as an anode to the scan electrode and applying an address pulse operating as a cathode to the address electrode both during the address period.

2. The driving method of the plasma display panel according to claim 1, wherein
at least one of the subfields has a reset period before the address period, and
the driving method further includes the operation of applying an adjusting slope pulse voltage to the scan electrode after applying a write slope pulse voltage to the scan electrode during the reset period, in which the adjusting slope pulse voltage gradually increases from a third voltage not lower than a first voltage to a fourth voltage and the write slope pulse voltage gradually decreases from the first voltage to a second voltage.

3. The driving method of the plasma display panel according to claim 2, wherein
a voltage value of the scan pulse is higher than the fourth voltage.

4. The driving method of the plasma display panel according to claim 1, further comprising the operation of
applying a predetermined voltage lower than a voltage value of the scan pulse to the scan electrode to which the scan pulse is not applied, during the address period.

5. The driving method of the plasma display panel according to claim 1, wherein
the subfields each have a sustain period during which a sustain discharge is generated between the sustain electrode and the scan electrode repeatedly, after the address period, and
the driving method further includes the operation of applying a high-level voltage to the sustain electrode and applying a low-level voltage to the scan electrode at an outset of the sustain period, and applying alternately the high-level voltage and the low-level voltage to the sustain electrode and the scan electrode, respectively, during the sustain period.

6. A plasma display device comprising:
a plasma display panel; and
a driver unit driving the plasma display panel, wherein
the plasma display panel includes:
a first plate on which a sustain electrode and a scan electrode being adjacent to each other and plurally disposed, a dielectric layer, an address electrode extending in a direction intersecting with the sustain electrode, and a protective layer are sequentially stacked;
a second plate disposed to face the first plate via a discharge space; and
a barrier rib formed on the second plate and extending in the direction intersecting with the sustain electrode, wherein:
one edge part of the address electrode lies on the barrier rib and the other edge part of the address electrode lies on the discharge space;
one field for displaying one frame includes a plurality of subfields each having an address period; and
the driver unit applies a scan pulse operating as an anode to the scan electrode and applies an address pulse operating as a cathode to the address electrode both during the address period.

7. The plasma display device according to claim 6, wherein
at least one of the subfields has a reset period before the address period, and
the driver unit applies an adjusting slope pulse voltage to the scan electrode after applying a write slope pulse voltage to the scan electrode during the reset period, in which the adjusting slope pulse voltage gradually increases from a third voltage not lower than a first voltage to a fourth voltage and the write slope pulse voltage gradually decreases from the first voltage to a second voltage.

8. The plasma display device according to claim 7, wherein
a voltage value of the scan pulse is higher than the fourth voltage.

9. The plasma display device according to claim 6, wherein
the driver unit applies a predetermined voltage lower than a voltage value of the scan pulse to the scan electrode to which the scan pulse is not applied, during the address period.

10. The plasma display device according to claim 6, wherein
the subfields each have a sustain period during which a sustain discharge is generated between the sustain electrode and the scan electrode repeatedly, after the address period, and
the driver unit applies a high-level voltage to the sustain electrode and applies a low-level voltage to the scan electrode at an outset of the sustain period, and alternately applies the high-level voltage and the low-level voltage to the sustain electrode and the scan electrode, respectively, during the sustain period.
